(19) United States
(12) Patent Application Publication
(10) Pub. No.: US 2010/0042655 A1
(43) Pub. Date: Feb. 18, 2010

(54) METHOD FOR SELECTIVE COMPRESSION FOR PLANNED DEGRADATION AND OBSOLENCE OF FILES

(75) Inventors: Francis K. Tse, Rochester, NY (US); Minette Ann Beabes, Rochester, NY (US); Ramesh Nagarajan, Pittsford, NY (US); Susan Marie Zak, Canandaigua, NY (US)

Correspondence Address: BASCH & NICKERSON LLP, 1777 PENFIELD ROAD, PENFIELD, NY, 14526, US

(73) Assignee: Xerox Corporation, Norwalk, CT (US)

(21) Appl. No.: 12/193,324

(22) Filed: Aug. 18, 2008

(51) Int. Cl. G06F 17/30

(52) U.S. Cl. 707/200; 707/E17.005

(57) ABSTRACT

A system and method manages a file storage system by defining an arbitration policy, the arbitration policy defining a pre-defined usage level threshold and defining implementation priorities for a plurality of storage management mitigation actions, each storage management mitigation action defining a distinct action to be taken to reduce the usage level of the file storage system and a parameter for selecting which file or files stored in the file storage system qualify for the storage management mitigation action. If a usage level of the file storage system is greater than the pre-defined usage level threshold, a storage management mitigation action is selected from the plurality of storage management mitigation actions. Which files that qualify for the selected storage management mitigation action is determined and the selected storage management mitigation action is applied to the files determined to qualify for the selected storage management mitigation action to reduce the usage level of the file storage system.

### BACKGROUND

Modern multifunction reprographic devices include many functions including scanning, copying, and printing. They are commonly connected to a network which allows for remote use of the printing function. In addition many of these devices now include means for scanning a document and sending a digital image to a user over the network.

Another function that many multifunction reprographic devices provide is for storage of documents that have been scanned or printed. This storage allows for repeat printing or further processing at a future date. However, the storage capacity of the multifunction reprographic device is relatively limited compared to file storage devices on the network.

The limited storage space on the multifunction reprographic device is commonly managed by either providing for individual user accounts, or by limiting the time a given file may remain on the system.

Also, the device is commonly managed by providing a user interface that works over a network connection, for example through a web browser type of interface that allows system administrators to manage a fleet of multifunction reprographic devices in an organization from a central place.

However, the file storage space on a multifunction reprographic device is limited compared, for example, to that available on a dedicated network file sharing device. Hence, some mechanism is needed to manage the storage space on the multifunction reprographic device so that the storage space does not become used up making access to the storage space for new work difficult for the user. While management of the file space can be done by regular intervention by system administration personnel, such intervention is costly and time consuming. As an alternative, to simply delete files after some relatively short period is inflexible with regard to some users' needs.

Therefore, it would be desirable to implement a more flexible way to manage the storage space on a multifunction reprographic device that minimizes administrative personnel time and maximizes user flexibility.

Further, it would be desirable that such a process might establish a threshold level of usage on the file system at which action will be taken; review each file on the system in chronological order, oldest first when the usage of the file system reaches the threshold level; select a compression method or simple deletion for the file, the compression method chosen from a plurality of compression techniques; apply the selected compression method or deletion of the file; and provide a user interface to allow setting of the threshold level, the selection of compression levels and types of compression as well as other parameters.

### BRIEF DESCRIPTION OF THE DRAWING

The drawings are only for purposes of illustrating various embodiments and are not to be construed as limiting, wherein:

FIG. 1 illustrates in schematic form a multifunction reprographic device;

FIG. 2 illustrates, in flowchart form, a method for managing file system storage space;

FIG. 3 illustrates an arbitration architecture for controlling the actions taken when a threshold capacity of the storage capacity has been exceeded;

FIG. 4 illustrates a flowchart of one possible implementation of the arbitration process illustrated in FIG. 3;

FIG. 5 shows a flowchart of one possible implementation of an e-mail or notification procedure for storage mitigation;

FIG. 6 shows one possible embodiment of a purge mitigation process; and

FIG. 7 shows a possible embodiment of the compression mitigation process.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

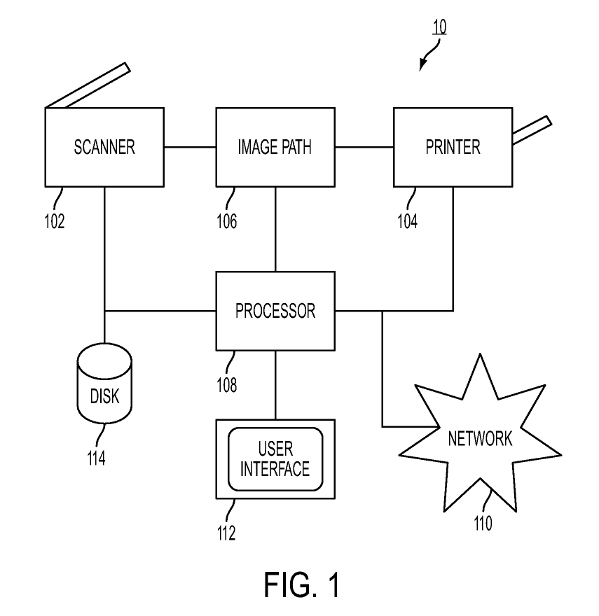

FIG. 1 shows a schematic depiction of a possible architecture or a multifunction reprographic device 10. The device includes a scanner 102, a print engine 104, an image path 106 for manipulating image data, and a processor 108. The device may be connected to a network via a network interface 110. There is also a user interface 112 connected to the processor 108.

The processor 108 may have non-volatile memory 114, for example, a hard disk drive. This non-volatile memory can be used to store various programs to be used by the processor 108 as well as for intermediate storage uses while processing print jobs.

The multifunction reprographic device 10 can operate as a copier by placing an original in the scanner 102 and selecting a copy function on the user interface 112. The processor 108 initiates a scanning operation from the scanner 102, sets up the image path 106 to properly process and format the image data from the scanner 102 for the print engine 104, and initiates the activity of the print engine 104 to print the image data from the image path 106.

Printing may be performed when a file is received via the network interface 110. The file may be a description of the pages to be printed, formatted in some sort of page definition language. The processor 108 processes the page definition language and converts the page definition language into image data in a format compatible with the print engine 104.

After receipt of the page definition language description of the document to be printed is received, the processor 108 begins the process of converting the page definition language into a printer compatible format. When the conversion of the page definition language to printer compatible format is complete, the image data is sent to the print engine 104 and printing is initiated. During this process, the image path 106 and the non-volatile memory 114 may also be used.

A function that is becoming more common is to use the scanning function of the multifunction reprographic device as a way to scan/convert a hardcopy of a document to an electronic file and then send the electronic file to a remote location. A user places a document to be scanned on the scanner 102, and initiates a scan to file operation via the user interface 112. The document is scanned, page by page, and converted to some form of page image data. Such form might be, for example, a JPEG or TIFF file. As the pages of the input document are scanned, the pages may be stored in non-volatile memory 114. During the conversion process, the image path 106 may also be used to assist in the conversion process, or the entire conversion can be performed by the processor 108.

When such a scan to file process is used, the user commonly specifies an e-mail address to which the complete scanned file is to be sent. However, the user may elect to leave the file in the non-volatile memory 114, at least temporarily.

Thus, one of the functions of the multifunction reprographic device 10 with such facilities is to use the non-volatile memory 114 to store files that arise during printing or scanning operations. This will allow users of the multifunction reprographic device 10 to print a job and then later request extra prints. Similarly, a scanned document can be stored for later access.

It is also possible for access to the non-volatile memory 114 to be available or controlled from remote locations by suitable communication devices and/or protocols through the network connection 110.

A problem arises due to the relatively limited space available in the non-volatile memory 114 of the multifunction reprographic device 10. While the multifunction reprographic device 10 acts as a file server, it is not usually designed with that as a primary mission and hence the size of the non-volatile memory 114 is limited compared to those of a dedicated file server. Hence, as users accumulate and store print and scan jobs, the storage space in the non-volatile memory 114 will quickly be used up.

A simple way to alleviate this problem is to set up the processor 108 to periodically scan the files stored in the non-volatile memory 114 and delete those older than some predetermined time limit. Another alternative is to set up user accounts with limited storage capacity to allow users to control their usage of the in the non-volatile memory 114.

Both of these approaches lack flexibility. The automatic deletion of files may not accommodate those users or jobs that require that a document be left in the multifunction reprographic device 10 for longer than the standard delete period. Setting up user accounts limits the number and set of users that have access to all the features of any particular multifunction reprographic device. In addition, these methods may require intervention of system administrative personnel, thus increasing the expense and availability of the multifunction reprographic device.

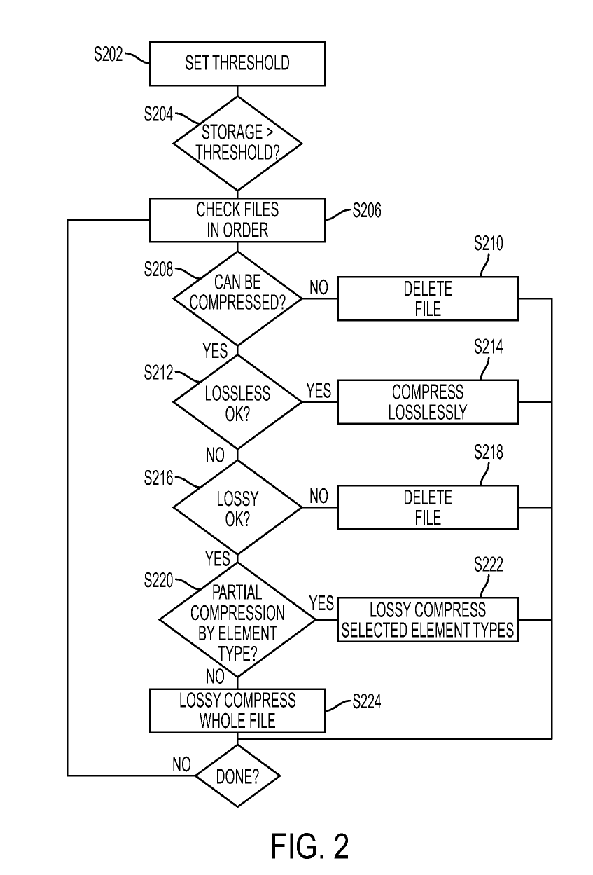

An alternative method is shown in FIG. 2. As illustrated in FIG. 2, options are enabled to allow for several alternatives other than simple deletion. These include selective degradation of files by use of compression before complete deletion. The compression can be from either a lossless method or various lossy methods.

Further, it is also possible to compress only parts of the document; in particular, those parts of the document that are particularly large, for example, image data.

Thus, compression can allow files to remain in storage longer while reducing the impact on storage capacity and allowing the users to retain a usable version of the stored documents for longer periods of time.

Referring to FIG. 2, a threshold level of file system usage is set at Step S202. This parameter can be set once during setup of the multifunction reprographic device or it can be changed dynamically. Typically this threshold might be in the range of 50-80% of the maximum capacity of the storage facility.

At step S204, a check is made to see if the storage usage exceeds the set threshold level. If the usage exceeds the threshold set at Step S202, the process proceeds to at Step S206 wherein a file is selected. Typically, the files are selected in reverse chronological order; that is oldest first.

At step S208, compressibility of the file is determined. The file may have previously been compressed and no further compression is possible. In such a case, the file is deleted at Step S210 and control continues with the next file. The range of compression methods can include both lossless and lossy compression methods.

If the file can be compressed, a check is first made in at Step S212 to see if sufficient compression can be achieved by applying some form of lossless compression. Such a compression might include RLL compression or some form of Lempel-Ziv compression, or other techniques well known in the art. If lossless compression is sufficient, the compression is applied in at Step S214 and control continues with the next file.

If the file cannot be compressed losslessly, a check is made in at Step S216 to see if sufficient compression can be achieved by applying some form of lossy compression. If lossy compression is not sufficient, the file is deleted at Step S218 and control continues with the next file.

However, if lossy compression can reduce the file size sufficiently, a further check is made in at Step S220 to see if only parts of the document can be compressed.

It is typical that for many documents there are certain content types that take up a large part of the document size. Most commonly, these content types include imaginal data like photographs. If lossy compression of only these content elements can reduce the document size, only these elements of the document are compressed lossy, thereby minimizing the impact of compression on overall file quality.

For example, image data in a document can be compressed using JPEG compression which is lossy but textual data in a document can be compressed using some sort of lossless compression, for example RLE encoding. The level of compression in JPEG can be selected—increasing levels of compression give rise to increasingly reduced levels of image quality of the compressed images.

Thus, the use of a lossy compression method allows for of compression with successively increasing levels of loss to take place before the only option is to delete the document from the storage system.

In order for such selective compression of only certain elements within the document to be possible, it is necessary to identify the location of the elements within the electronic form of the document. This can be accomplished by tagging techniques applied at the scanning stage. Such document segmentation techniques are well known and will not be discussed here, except to note that typically as the document is scanned a tag file is generated where the tag file identifies the location of each type of content within the document. The tag file can thus be used to select only parts of the document to be compressed.

If the document is capable of being selectively compressed, at Step S222 only those elements of the document are lossly compressed. This process will use the tag file mentioned previously to locate the particular content elements that are to be compressed. If the document is not capable of being selectively compressed, the whole document is lossly compressed at Step S224. Afterwards control proceeds to the next file.

The process continues scanning the files on the file storage until all files have been scanned. If after all files have been processed, the file storage usage is still above threshold, the process will be applied again until enough space has been released for general usage.

The option to selectively lossly compress only certain elements of documents can be made either as an overall policy decision or on a document by document basis. In the latter case, an option can be made available on the user interface that allows each user to select whether to allow for selective compression or not.

With a multi-function printing device or a printer acting as a file server, file metadata can be used to determine the compression algorithms to be utilized and the selective compression needed within a file to retain the expected image quality. Through the use of selective compression techniques, files, which have an older scan date, accessed infrequently, or have a preference for keeping the image quality of text or pictures (signatures, for example), can be compressed more tightly to allow more room on the hard drive.

By providing this flexibility, a system administrator can have the ability of selectively controlling the storage space in a multi-function printing device or a printer acting as a file server without having to immediately purge all the documents. This control can be provided through a Web User Interface and or other interface software so that a system administrator can configure all the devices in an enterprise in a consistent manner.

Additionally, this selective compression can be triggered automatically by the multi-function printing device controller, and a system administrator can be notified, via e-mail or other communication channel or protocol, ahead the action. The system administrator could still have the flexibility to turn OFF the feature based on numerous factors.

As noted above, a system administrator can set up a multi-function printing device with options to efficiently manage the document storage space.

For example, a system administrator can set a storage space threshold (e.g., a threshold of 80% of capacity) such that when the threshold is exceeded, certain actions can be taken to reduce the amount data being stored.

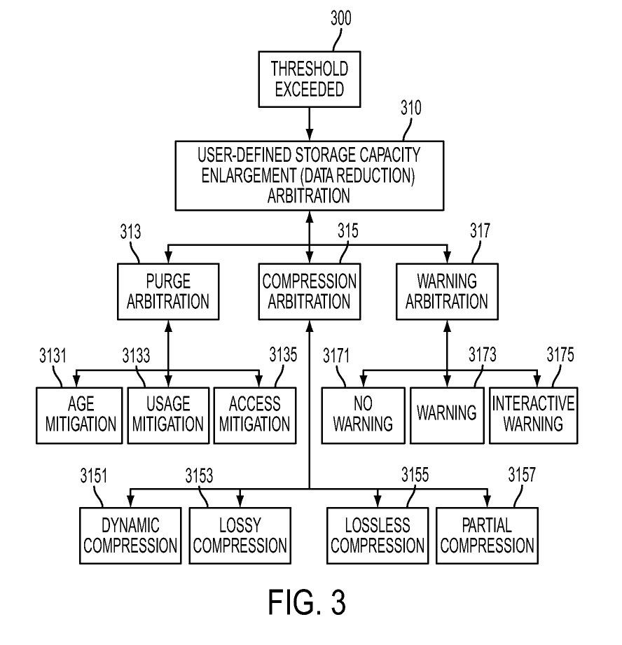

FIG. 3 illustrates a block diagram architecture for arbitrating the various possible actions to be taken to reduce the data in storage when the threshold capacity has been exceeded. As illustrated in FIG. 3, it has been determined that a threshold capacity has been exceeded (300). Upon determining that a threshold capacity has been exceeded, a user-defined storage capacity enlargement (data reduction) arbitration process is implemented (310).

The data reduction arbitration process may include a purge arbitration module (313), a compression arbitration module (315), and a warning arbitration module (317). These various modules (purge (313), compression (315), and warning (317)) may be implemented in parallel, serially, dependently, or independently, as defined by a user (system administrator).

For example, upon determining that a threshold capacity has been exceeded, a user may have defined the post threshold actions to include a warning (3173) to the user. This warning may be an e-mail or other pre-defined form of communication. On the other hand, upon determining that a threshold capacity has been exceeded, a user may have defined the post threshold actions to be carried out automatically without a warning (3171) to the user.

Lastly, the warning (3175) may include pre-defined actions for the user to select so as to reduce the size of the data in storage. In such an interactive warning (3175), the user may receive a detailed communication listing all possible actions requiring the user to select the desired actions.

Moreover, the warning arbitration module (317) may initially poll the purge arbitration module (313) and/or the compression arbitration module (315) to determine the viable options to reduce the size of the data in storage.

In this polling, the purge arbitration module (313) may provide a list of old documents as possible candidates for purging (e.g., a list of documents more than X days old) from an age mitigation module or process (3131), a list of last accessed documents as possible candidates for purging (e.g., a list of documents more than Y days since last accessed) from an usage mitigation module or process (3133), a list of least used documents as possible candidates for purging (e.g., a list of documents having been accessed no more than Z times) from an access mitigation module or process (3135), and/or a combination of any or all of these lists. The list can be sorted, based on various parameters, so that the user can properly evaluate the situation and select the appropriate documents, if any, to be purged.

In the age mitigation module or process (3131), the stored documents are analyzed based upon the amount of time that the document has resided in memory. The age mitigation module or process (3131) may generate just a list of documents with associated age information (in ascending or descending order) or a list of documents that have resided in memory for a period of time greater than a user defined period of time. The age mitigation module or process (3131) may also produce information as to the retention classification of document, such as a template, legal, etc., which may override a user defined age parameter (a retention classification for a legal document requiring retention of 15-years).

It is noted that this additional information may also be produced and/or processed in the purge arbitration module (313), and thus the additional information can be used to modify the information generated by the age mitigation module or process (3131), usage mitigation module or process (3133), and/or access mitigation module or process (3135).

In the usage mitigation module or process (3133), the stored documents are analyzed based upon the number of times that the document has been retrieved from the memory. The usage mitigation module or process (3133) may generate just a straight list of documents with associated usage information (in ascending or descending order) or a list of documents that have been retrieved from the memory less than a user defined usage level. The usage mitigation module or process (3133) may also produce information as to the quality of the usage, such as diversification of the users retrieving the document (same user over and over again, or multiple users) or purpose of the retrieval, such as retrieval for reviewing only or retrieval for modification.

It is noted that this additional information may also be produced and/or processed in the purge arbitration module (313), and thus the additional information can be used to modify the information generated by the age mitigation module or process (3131), usage mitigation module or process (3133), and/or access mitigation module or process (3135).

In the access mitigation module or process (3135), the stored documents are analyzed based upon the amount of time since the last access of the document in memory. The access mitigation module or process (3133) may generate just a list of documents with associated access information (in ascending or descending order) or a list of documents that have not been accessed for a period of time greater than a user defined period of time.

Moreover, in the above-mentioned polling, the compression arbitration module (315) may provide a list of documents as possible candidates for lossy compression from a lossy compression mitigation module or process (3153), a list of documents as possible candidates for lossless compression from a lossless compression mitigation module or process (3155), a list of documents as possible candidates for partial compression (e.g., a list of documents having data not conductive to compression) from a partial compression mitigation module or process (3157), a list of documents as possible candidates for dynamic compression (e.g., a list of documents having data conductive to compression) from a dynamic compression mitigation module or process (3151), and/or a combination of any or all of these lists. The list can be sorted, based on various parameters, so that the user can properly evaluate the situation and select the appropriate documents, if any, to be compressed.

In the lossy compression mitigation module or process (3153), the stored documents are analyzed based upon the type of data within the document to determine if the data can be compressed using a lossy compression process without significantly impacting the document's quality. The lossy compression mitigation module or process (3153) may generate just a list of documents with associated compression ratio information (in ascending or descending order) or a list of documents that have a compression ratio greater than a user defined ratio. The lossy compression mitigation module or process (3153) may also produce information as to the quality of the document after compression which may override a user defined compression ratio parameter.

It is noted that this additional information may also be produced and/or processed in the compression arbitration module (315), and thus the additional information can be used to modify the information generated by the lossy compression mitigation module or process (3153), lossless compression mitigation module or process (3155), partial compression mitigation module or process (3157), and/or dynamic compression mitigation module or process (3151).

In the lossless compression mitigation module or process (3155), the stored documents are analyzed based upon the type of data within the document to determine if the data must be compressed using a lossless compression process so as to avoid significantly impacting the document's quality. The lossless compression mitigation module or process (3155) may generate just a straight list of documents with associated compression ratio information (in ascending or descending order) or a list of documents that have a compression ratio greater than a user defined ratio. The lossless compression mitigation module or process (3155) may also produce information as to the quality of the document after compression which may override a user defined compression ratio parameter.

It is noted that this additional information may also be produced and/or processed in the compression arbitration module (315), and thus the additional information can be used to modify the information generated by the lossy compression mitigation module or process (3153), lossless compression mitigation module or process (3155), partial compression mitigation module or process (3157), and/or dynamic compression mitigation module or process (3151).

In the partial compression mitigation module or process (3157), the stored documents are analyzed based upon the types of data within the document to determine if certain data (e.g., image data versus text) within the document can be compressed using a compression process so as to avoid significantly impacting the document's quality. The partial compression mitigation module or process (3157) may generate just a list of documents with associated compression ratio information (in ascending or descending order) or a list of documents that have a compression ratio greater than a user defined ratio. The partial compression mitigation module or process (3157) may also produce information as to the quality of the document after compression which may override a user defined compression ratio parameter.

It is noted that this additional information may also be produced and/or processed in the compression arbitration module (315), and thus the additional information can be used to modify the information generated by the lossy compression mitigation module or process (3153), lossless compression mitigation module or process (3155), partial compression mitigation module or process (3157), and/or dynamic compression mitigation module or process (3151).

In the dynamic compression mitigation module or process (3151), the stored documents are analyzed based upon the types of data within the document to determine if the document can be compressed using a compression process so as to avoid significantly impacting the document's quality. The dynamic compression mitigation module or process (3151) may generate just a list of documents with associated compression ratio information (in ascending or descending order) or a list of documents that have a compression ratio greater than a user defined ratio.

The user can then select which document to compress and evaluate the post compressed document's quality to determine if a more aggressive compression method should be utilized. If the user selects a more aggressive compression method, the document is again compressed and evaluated, thereby allowing the user to select the appropriate compression method.

In the alternative, the dynamic compression mitigation module or process (3151) can produce a list of documents with associated compressed ratio and quality information; e.g., a document is compressed using a plurality of compression methods to generate a plurality of distinctly compressed documents, each having an associated quality, and thus, based on the choices of distinctly compressed documents for a single document, the user can choose the appropriate compressed document for retention.

The dynamic compression mitigation module or process (3151) may also produce information as to the quality of the document after compression which may override a user defined compression ratio parameter.

It is noted that this additional information may also be produced and/or processed in the compression arbitration module (315), and thus the additional information can be used to modify the information generated by the lossy compression mitigation module or process (3153), lossless compression mitigation module or process (3155), partial compression mitigation module or process (3157), and/or dynamic compression mitigation module or process (3151).

Given the various possible actions to reduce the size of the data in a memory, the user can predefine parameters for the user-defined storage capacity (data reduction) arbitration module or process (310) so that compression may be the preferred action over purging, purging may be the preferred action over compression, or some mitigated combination of the two types of actions.

It is further noted that at the time of storing or scanning, a user can be provided with an option of identifying areas of the documents that are most important to the user (i.e., text, pictures, graphics, signature, etc.). This can be accomplished simply by picking those general terms from a user interface or by highlighting those areas in a preview image. This information can then be stored as metadata along with the document.

It is noted that in many conventional workflows, the documents used are standard forms and areas of interest may be consistently in the same region; therefore, the selection may have to be done only once per job or template. (If the same region is relevant for all the pages in a job, the user will select “apply to all pages” on the local user interface.

Alternatively, instructions could be stored in a template that could be used with the job. The system controller can continuously monitor the storage space available and when the storage space available reaches a certain threshold, the system controller will mark certain documents as being “older” based on the criteria set up by the user or system administrator.

An e-mail can be sent to the user or system administrator of the action that is going to be taken. The user or system administrator may have the option of canceling the action.

If the action is to be executed, the system controller can either aggressively compress and/or purge the ‘older’ documents based on the action parameters specified by the user or system administrator. When selective compression is invoked, the additional metadata information can be used for compressing selective portions of the document. When no metadata is available, a default option can be to compress the pictorial regions more aggressively and retain the text quality for later retrieval.

For example, system controller may perform selective compression within a file, based on whether the primary information is text or graphics, e.g. via automatic image segmentation or user selection, to reduce temporary storage space requirement.

The type of compression can also be driven by age parameters, usage parameters, and/or access parameters. For example, an old (age greater than a user defined age), infrequently used (usage less than a user defined usage), and/or not accessed (last access more than a user defined time period) document may be more aggressively compressed than a young (age less than a user defined age), frequently used (usage greater than a user defined usage), and/or recently accessed (last access less than a user defined time period) document without regard for document quality.

Alternatively, the document's age, usage, access parameters may define whether a lossy compression method or a lossless compression method is utilized.

Furthermore, the document's age, usage, access parameters may define an iterative compression process such that the document image quality is gracefully degraded over time or compression processes.

It is noted that a final policy parameter can set the point at which the storage management arbitration process terminates. One option is to examine all files in storage once the action threshold is reached. Under this option, all files are examined and processed. An alternative is to process files until some level of storage usage is reached. Such a level would be some amount below a level which would trigger the arbitration process so that the system is not constantly invoking the storage management arbitration process each time a file is added to the system. Such a threshold level would be set as part of the policy decision.

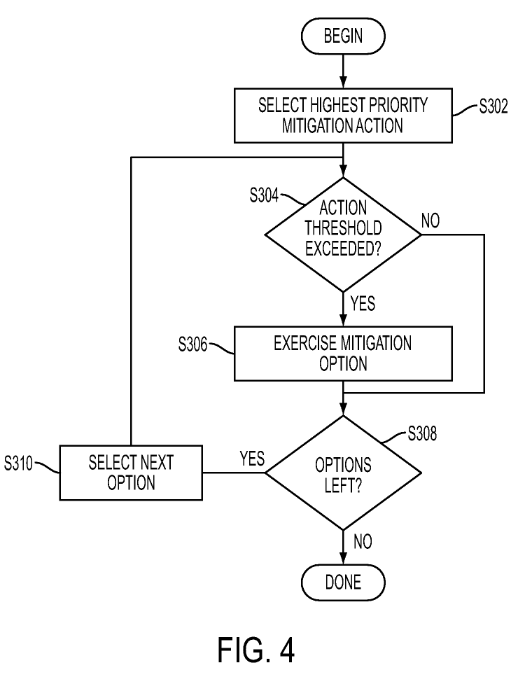

With respect to FIG. 4, FIG. 4 illustrates a flow diagram of one possible implementation of the arbitration process illustrated in FIG. 3. The process is started either at a periodic interval or else in response to the level of usage of the system reaching some threshold. The choice of trigger and its parameters (period or usage level) are part of the policy setting process.

As illustrated in FIG. 4, at step S302, the user/administrator selects or pre-defines the highest priority mitigation procedure. By setting priorities, the user/administrator can establish the policy that enables the reduction of the data in capacity.

At step S304, the threshold level for the chosen mitigation procedure is examined. For example if the threshold is set to be a certain level of usage of the file system, the system usage is compared to this parameter. If the threshold is exceeded, the mitigation procedure proceeds to step S306.

After completing the mitigation procedure (as described above with respect to FIG. 3) at step S306, a check is made at step S308 to see if any other mitigation procedures remain available. If so, the next procedure in terms of priorities is selected at step S310 and control returns to step S304. When all mitigation procedures are completed, control exits and the arbitration process is complete.

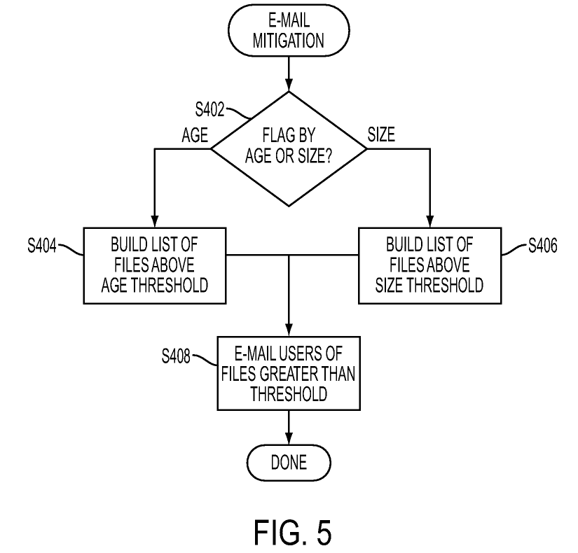

FIG. 5 shows a flowchart of one possible implementation of an e-mail or notification procedure for storage mitigation. This procedure does not actually remove or change any files stored on the system, but rather, it notifies a user/administrator requesting that certain actions may be taken or should be taken with regard to one or more files which have been stored on the system.

As noted above, a user/administrator's response can result in the removal of files from the system. The action can be communicated to the system via a user interface, either on the machine itself or via a network connection, return e-mail, or other channel of communication which will effectively communicate the appropriate instructions to the system.

An additional embodiment could allow users to request an extension of time for the file to remain on the system.

The e-mail mitigation process begins at step S402 by checking to see if the files should be flagged either by date or by size. The choice is another parameter of the policy setting process.

If the files are flagged by age, control transfers to step S404 where a list of files greater than an age threshold is built. The age threshold is also a parameter of the policy setting process.

If the files are flagged by size, control transfers to step S406 where a list of files greater than a size threshold is built. From either steps S404 or S406, control passes to step S408 where the file list is used to send e-mail to the user of each file identified requesting action to be taken or notifying the user of the action that will be taken.

It should be noted that as described here the e-mail system may be configured to solicit a voluntary response such that is no further action is needed by the user. In such a configuration, the combined arbitration-mitigation process eventually processes any file based upon the policy pre-defined by the user/administrator.

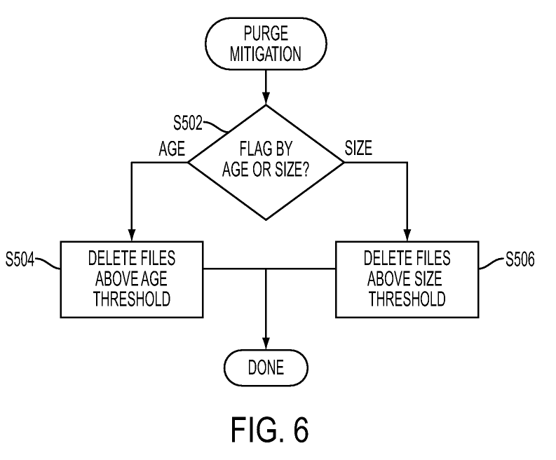

FIG. 6 shows one possible embodiment of a purge mitigation process. In this embodiment, files can be purged or deleted from the system. The candidates for purging can be determined based upon the file exceeding a certain size threshold, or alternatively, the file being older than an age threshold. Alternative embodiments could include a more complex purge decision based on some combination of age and size parameters.

As illustrated in FIG. 6, at step S502, the policy is checked to see if an age or size determination is to guide the purge process. If the decision is to use an age-related purge, control proceeds to step S504 where all files that exceed the age threshold may be deleted.

If the policy is to use a size determination to guide the purge process in step S502, control transfers to step S506. In step S506, all files that exceed the size threshold may be deleted.

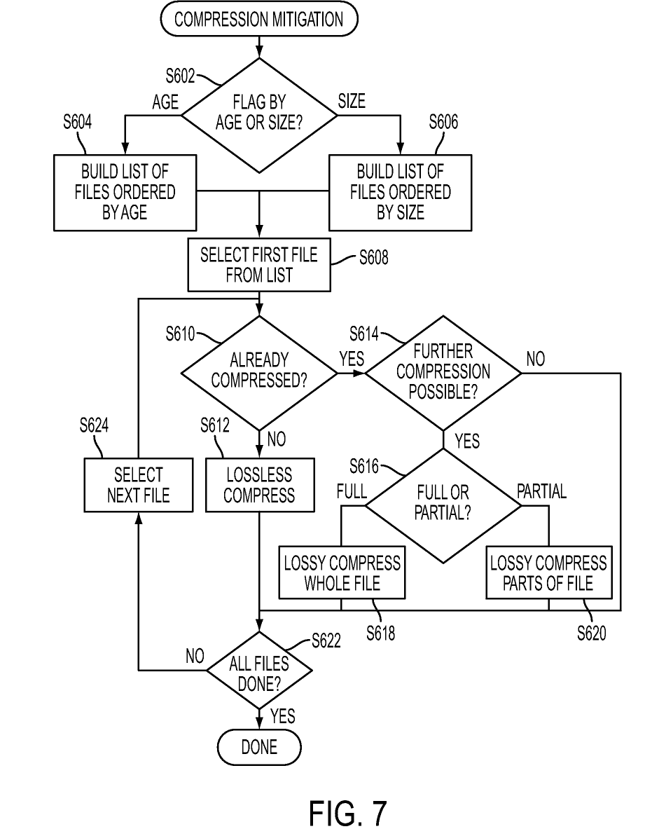

FIG. 7 shows a possible embodiment of the compression mitigation process. The compression mitigation process increases the available space on the file system by compressing one or more of the files already on the system.

As noted above, compression is allowed to proceed through several distinct steps. Initially, a file can be examined to see if it can be losslessly compressed. This compression option enables that no information is lost from the file. Such a compression might include some form of run-length encoding, Lempel-Ziv compression, or other techniques well known in the art.

If a lossless compression is not available either because of the content of the file or because the file has already been losslessly compressed, a lossy compression option is considered. The lossy options can result in a further compression of the file, but at the cost of some loss of information in the file.

In most cases, this information loss manifests itself as a loss of image quality of the file when printed. Thus, the use of a lossy compression method allows for compression with successively increasing levels of loss to take place before the only other option is to delete the document from the storage system.

Another possible option is to compress only parts of the file. This option is useful when the file contains certain identifiable elements that comprise a large part of the file size. A common example of such a case is a document with several embedded photo-realistic images therein. In such a case, the images may be the dominant component of the file in terms of size. Such image data in a document can be compressed using JPEG compression which is lossy, but the textual data in a document can be compressed using some sort of lossless compression, for example run-length encoding.

The level of compression in JPEG can be selected—increasing levels of compression give rise to increasingly reduced levels of image quality of the compressed images. By applying a lossy compression to these elements within the file, the file can be reduced in size while minimizing or localizing any information loss or quality degradation.

In order for such selective compression of only certain elements within the document to be possible, it is necessary to identify the elements' locations within the electronic form of the document. This can be accomplished by tagging techniques applied at the scanning stage or other types of electronic classification processes. Such document classification/segmentation techniques are well known and will not be discussed here, except to note that typically as the document is scanned or processed, a tag file is generated where the tag file identifies the location of each type of content within the document. The tag file can thus be used to select only parts of the document to be compressed.

The option to selectively lossly compress only certain elements of documents can be made either as an overall policy decision or on a document by document basis. In the latter case, an option can be made available on the user interface that allows each user to select whether to allow for selective compression or not.

As illustrated in FIG. 7, at step S602, the policy is checked to see if an age or size determination is to guide the purge process. If the decision is to use an age-related purge, control proceeds to step S604 where a list of files that exceed the age threshold is created.

If the policy is to use a size determination to guide the purge process in step S602, control transfers to step S606. In step S606, a list of all files that exceed the size threshold is created.

After either steps S602 or S604, control passes to a compression process, which begins at step S608, with the selection of the first file in the list. A check is made at step S610 to see if the file has already been compressed.

If the file has not, control passes to step S612 where lossless compression is applied to the file. If, at step S610, the file has already been compressed, a check is made at step S614 to see if further compression is possible.

If no further compression is possible, control passes to step S622. If further compression is possible, a further check is made at step S616 to see if the entire file is to be compressed or if the option to selectively compress only parts of the file is available.

Depending on which option is available at step S616, either the entire file is compressed at step S618 or only those elements of the file that are selectively allowed are compressed at step S620.

At step S622, a check is made to see if all files on the list have been processed. If all files on the list have not been processed, the next file on the list is chosen at step S624 and control returns to step S610. The process repeats until all files have been processed.

It should be noted that although the above processes have been described within the context of file storage on a multifunction reprographic machine, the above processes are also applicable to any shared file storage system.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of managing file storage comprising:
defining an arbitration policy, the arbitration policy defining a pre-defined usage level threshold and defining implementation priorities for a plurality of storage management mitigation actions, each storage management mitigation action defining a distinct action to be taken to reduce the usage level of the file storage system and a parameter for selecting which file or files stored in the file storage system qualify for the storage management mitigation action;
determining if a usage level of the file storage system is greater than the pre-defined usage level threshold;
selecting a storage management mitigation action from the plurality of storage management mitigation actions when it is determined that the usage level of the file storage system is greater than the pre-defined threshold and based upon the defined implementation priorities;
determining which files in the file storage system qualify for the selected storage management mitigation action; and
applying the selected storage management mitigation action to the files determined to qualify for the selected storage management mitigation action to reduce the usage level of the file storage system.

2. The method as claimed in claim 1, further comprising:
informing an owner of a determined file of the selected storage management mitigation action before applying the selected storage management mitigation action to the file;
enabling the owner to override the selected storage management mitigation action for the determined file; and
preventing the application of the selected storage management mitigation action to the determined file.

3. The method as claimed in claim 1, further comprising:
informing an owner of a determined file of the selected storage management mitigation action before applying the selected storage management mitigation action to the file;
enabling the owner to select a different storage management mitigation action for the determined file; and
applying the owner selected storage management mitigation action to the determined file.

4. The method as claimed in claim 1, wherein a storage management mitigation action is lossless compression.

5. The method as claimed in claim 1, wherein a storage management mitigation action is lossly compression.

6. The method as claimed in claim 1, wherein a storage management mitigation action is a partial compression.

7. The method as claimed in claim 1, wherein a storage management mitigation action is a purging based on age of file.

8. The method as claimed in claim 1, wherein a storage management mitigation action is a purging based on usage frequency of file.

9. The method as claimed in claim 1, wherein a storage management mitigation action is a purging based on a time period between accessing of the file.

10. A method of managing file storage comprising:
defining an arbitration policy, the arbitration policy defining a pre-defined usage level threshold, and defining an implementation of a compression mitigation action to reduce the usage level of the file storage system and a parameter for selecting which file or files stored in the file storage system qualify for the compression mitigation action, the compression mitigation action includes lossless compression, lossly compression, and partial compression;
determining if a usage level of the file storage system is greater than the pre-defined usage level threshold;
determining which files in the file storage system qualify for the compression mitigation action based upon the defined implementation of the compression mitigation action;
classifying the determined files based upon a content type within the determined files, as lossless candidates, lossly candidates, or partial candidates; and
applying, based upon the classification of the file, lossless compression, lossy compression, or partial compression upon the files determined to qualify for the compression mitigation action to reduce the usage level of the file storage system.

11. The method as claimed in claim 10, wherein a file classified as a partial candidate has a portion of the file compressed using lossless compression and a portion of the file compressed using lossly compression.

12. The method as claimed in claim 10, wherein a file classified as a partial candidate has a portion of the file not compressed and a portion of the file compressed using lossly compression.

13. The method as claimed in claim 10, wherein a file classified as a partial candidate has a portion of the file not compressed and a portion of the file compressed using lossless compression.

14. The method as claimed in claim 10, wherein the compression mitigation action includes dynamic compression such that a user selects a compression technique based upon an acceptable image quality of the compressed file.

15. The method as claimed in claim 10, wherein the files determined to qualify for the compression mitigation action is based on an age of file.

16. The method as claimed in claim 10, wherein the files determined to qualify for the compression mitigation action is based on usage frequency of file.

17. The method as claimed in claim 10, wherein the files determined to qualify for the compression mitigation action is based on a time period between accessing of the file.

18. The method as claimed in claim 11, wherein the user specifies which portion of the file is lossless compressed and which portion of the file is lossly compressed.

19. The method as claimed in claim 12, wherein the user specifies which portion of the file is not compressed and which portion of the file is lossly compressed.

20. The method as claimed in claim 13, wherein the user specifies which portion of the file is not compressed and which portion of the file is lossless compressed.
